(19) United States
(12) Patent Application Publication
(10) Pub. No.: US 2024/0238933 A1
(43) Pub. Date: Jul. 18, 2024

(54) METHOD FOR MECHANICAL TREATMENT OF A CONCRETE FLOOR

(71) Applicant: CONCRIA OY, YIöJärvi (FI)

(72) Inventor: Mika AHONEN, Kyröskoski (FI)

(73) Assignee: CONCRIA OY, YIöJärvi (FI)

(21) Appl. No.: 18/560,269

(22) PCT Filed: May 6, 2022
(86) PCT No.: PCT/FI2022/050303

§ 371 Date: Nov. 10, 2023

(30) Foreign Application Priority Data
May 14, 2021 (FI) 20215570

(51) Int. Cl. B24B 7/22; C04B 41/00; C04B 41/68; C04B 111/60; E04F 21/24

(52) U.S. Cl. CPC B24B 7/224; C04B 41/009; C04B 41/68; E04F 21/245; C04B 2111/60

(57) ABSTRACT

A method for a mechanical treatment of a concrete floor, such as troweling and blade finishing, using a hand-operated, a walk-behind or a ride-on actuator, such as a concrete power trowel machine, a floor treatment machine or the like, is described. The actuator has one or more operating heads comprising a rotor consisting of two or more attachment arms. The floor surface is treated by means of concrete troweling elements, such as circular trowel pans or elongated trowel blades attached to the rotor attachment arms, made substantially of plastic material, that are detachably coupled to the rotor of the actuator, in particular to prevent discoloration of the treated floor surface during treatment. Before the concrete floor is troweled with plastic-based concrete troweling elements, a water-soluble silica-based medium is applied on it.

The invention relates to a method as presented in the preamble of the independent claim directed thereto for mechanical treatment of a concrete floor surface, such as troweling and blade finishing, by using a hand-operated, a walk-behind or a ride-on actuator.

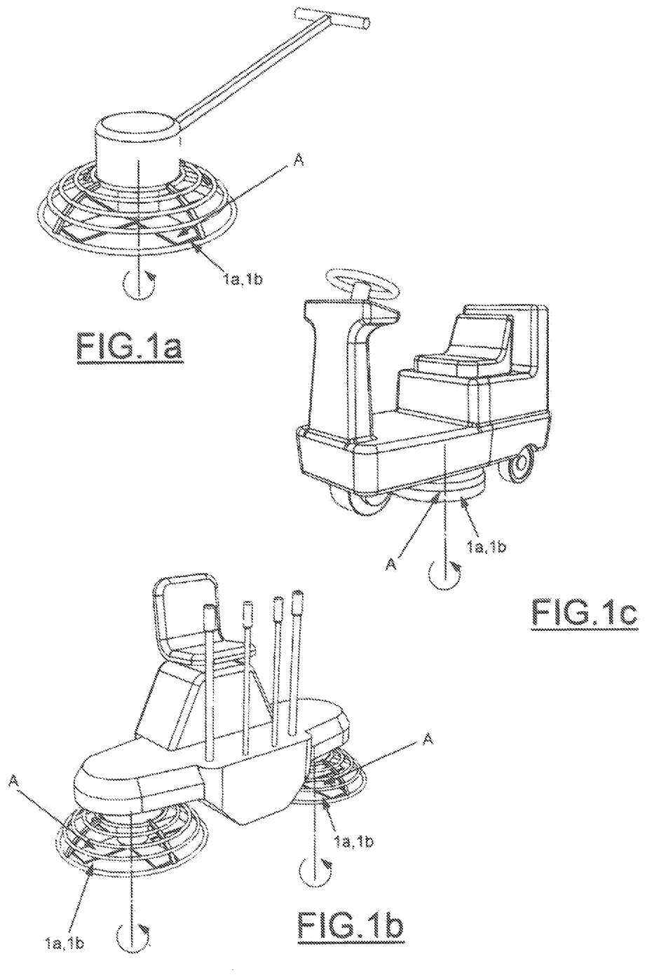

A common practice in the foregoing purpose is to employ a concrete power trowel of e.g., the manual walk-behind type shown in FIG. 1a, the ride-on type concrete power trowel of the type shown in FIG. 1b or a floor treatment machine of the type shown in FIG. 1c. An operating head of such an actuator, i.e. a so-called rotor, consists of two or more attachment arms that are fitted with the concrete troweling elements used for the mechanical treatment of the concrete floor.

In the power troweling of e.g. a concrete floor to be prepared, it is conventional to use a one-piece circular metal trowel pan or metal troweling blades attached to its attachment arms as concrete troweling elements connected to the rotor of the actuator.

Currently, a problem when using concrete troweling elements made of metal is the discoloration of the floor surface when troweling e.g. concrete, epoxy and dry-shake coated floors, which has been found to be caused on the one hand by friction induced heating of the metallic trowel pan and, on the other hand by varying humidity of the concrete floor to be prepared. Therefore, there are in service plastic trowel pans and blades, the use of which currently makes it possible to avoid the discoloration of the floor surface.

In practice, the most common reasons differences in concrete floors are:
insufficient or inhomogeneous moisture in the concrete floor,
varying casting conditions (wind, sunlight, rain),
the use of a plasticized concrete mix (in order to reduce the water/cement ratio of the concrete),
the use of an air-entraining agent in the concrete mix, and
the use of blast furnace slag, fly ash or excessively fine aggregates in the concrete mixes.

For example, patent publication WO 2020/249847 discloses a method and arrangement for grinding e.g. concrete, epoxy and/or surface treated flooring. The floor surface is troweled by means of a trowel pan, which is detachably coupled to the actuator operating head and made substantially of a plastic-based material, in particular with the aim of preventing discoloration of the floor surface to be grinded during the troweling. For this purpose, the trowel pan is attached to the operating head of the actuator used for troweling of the floor surface by means of a velcro-type fastening principle, by using the detachable fastening surfaces that are, on the one hand, attached to the operating head of the actuator and, on the other hand, to the trowel pan. This solution significantly facilitates the preparation of the floor surface thanks to the easy interchangeability of the concrete troweling elements.

However, in practice it has been found that the use of plastic-based concrete troweling elements alone is not sufficient to prevent discoloration of the floor surface under all circumstances.

An objective of the method of the present invention is to provide a decisive improvement over the above-described problems and thereby to raise essentially the available prior art. In order to attain this objective, the method of the invention is principally characterized by what is presented in the characterizing part of the independent claim directed thereto.

Some of the most important benefits gained by the method of the invention should be noted to include its simplicity and effectiveness, which allow to prepare a concrete floor with optimal physical and visual characteristics under the most variable installation conditions and for the most demanding purposes of use. This is enabled, first of all, by the use of plastic-based concrete troweling elements for floor surface treatment and, second of all, by the application of a silica-based medium on the concrete floor surface prior to troweling or blade finishing, which, on the one hand prevents water evaporation from the concrete floor surface and, on the other hand seals the treated surface in a way similar to a so-called early post-treatment agent. In this case, the troweling or blade finishing of the floor concrete mix can be done evenly throughout the floor area, as the floor surface remains ‘fresh’ due to the silica-based medium reacting with the excess lime in the cement, thus accelerating the formation of the surface.

A further advantage of using a silicon dioxide nanoparticle-based medium, so-called nanosilica, is that the efficiency of concrete floor preparation is further enhanced significantly by allowing the very fine-grained nanosilica to penetrate into the pores of the concrete floor, further improving the strength of the concrete floor and smoothing out color differences without increasing the preparation time of the floor surface. As a further preferred embodiment of the method, a so-called colloidal silica fluid containing pure silica in adequately small nanoparticles capable to penetrate very effectively into the pore structures of the concrete floor is used. The colloidal calcium silicate forms a new calcium silicate hydrate (CSH) in the pore structures, that binds, additional to the calcium silicate hydrate in the concrete mix of the floor, to other silicates and to itself as well.

Other preferred embodiments of the method of the invention are presented in the dependent claims directed thereto.

In the subsequent description, the invention will be illustrated in detail while referring to the accompanying drawings, in which

FIGS. 1a-1c show one typical manual concrete power trowel with a rotor coupled with plastic-structured troweling blades, one typical ride-on concrete power trowel with plastic-structured troweling blades coupled to the rotors, and one typical ride-on floor 15 treatment machine, i.e. a so-called cleaning machine, with a plastic-structured trowel pan coupled to its rotor,

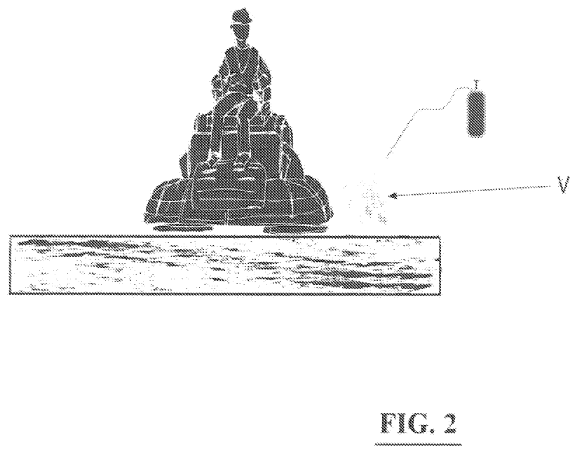

FIG. 2 shows a concrete floor treatment of the invention,

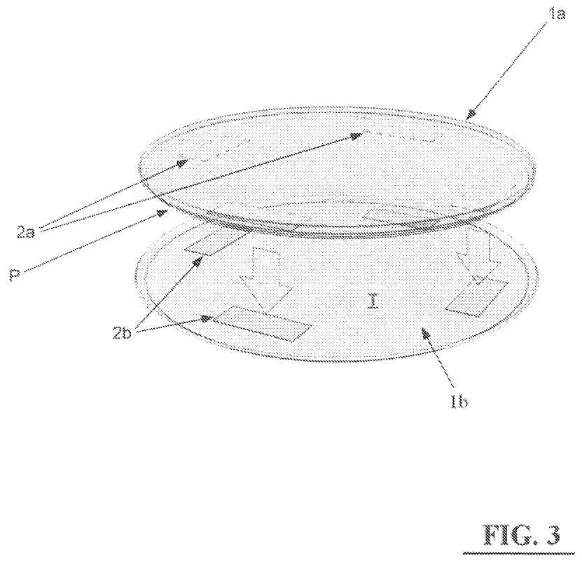

FIG. 3 shows a preferred trowel pan used in the method of the invention, and

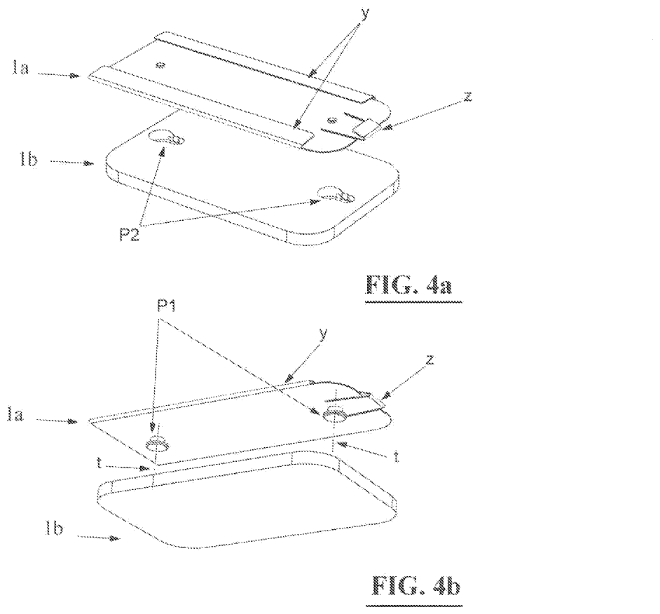

FIGS. 4a and 4b show in a top assembly view a preferred trowel blade used in the method of the invention.

The invention relates to a method for a mechanical treatment of a concrete floor, such as troweling and blade finishing, by using, for example with reference to FIGS. 1a to 1c, a hand-operated, walk-behind or ride-on actuator, such as a concrete power trowel machine, a floor treating apparatus or the like. The actuator includes one or more operating heads A comprising a rotor consisting of two or more attachment arms. In the treatment of the floor surface, concrete troweling elements 1b, such as a circular trowel pan or elongated trowel blades, made substantially of a plastic-based material, in particular to prevent discoloration of the treated floor surface during treatment, are attached to the rotor attachment arms, which are detachably coupled to the rotor. Before the concrete floor is treated with the plastic-based concrete troweling elements 1b, a water-soluble silica-based, medium V is applied on it as shown in FIG. 2.

The said silica-based medium on the one hand prevents water evaporation from the concrete floor surface and, on the other hand, seals the treated surface in a similar way to a so-called early post-treatment agent. In that case, the floor concrete mix is troweled or finished with blades evenly throughout the floor area, as the floor surface remains ‘fresh’ due to the silica-based medium reaction with the excess lime in the cement, thus accelerating the formation of the surface.

A further advantage of the silica-based medium, especially when processing a dry-shake layer on a concrete floor surface, is that it does not weaken the strength of the underlying concrete mix, as its use does not cause excessive moisture migration from the dry-shake layer to the underlying structure. This is due to the fact that the medium applied prior to troweling acts as a primer and accelerator of the reaction in the said process, whereas the use of water in this context increases the risk of excessive ‘wetting’ of the concrete mix making it difficult to finish, while also reducing the wear resistance of the concrete floor to be prepared.

As a further preferred embodiment of the method of the invention, a nanoparticle silicon dioxide (silica)-based medium is used. In particular, the so-called colloidal silica fluid contains pure silica in adequately small nanoparticles capable to penetrate even the smallest pore structures of the concrete floor surface. In that case the colloidal calcium silicate forms new calcium silicate hydrate (CSH) in the pore structures, which binds in addition to the calcium silicate hydrate in the previously processed concrete mix or, e.g., in the dry-shake surface processed over it, also to other silicates and to itself. Other silicate densifiers (such as lithium, sodium and potassium) have not been found to act in a similar way.

When using colloidal silica in the mechanical treatment of the concrete floor, the compression strength develops faster and the surface density increases, because due to use of colloidal silica no unreacted cement is left in the concrete surface.

This allows in turn the concrete surface to be troweled earlier than is currently possible, as grinding of normal untreated concrete can currently be carried out at the earliest 21-28 days after casting.

A further preferred embodiment of the method, with particular reference to FIGS. 3, 4a and 4c, a trowel pan made of ABS-, PS-, ABS+PC-, PETG-, PVC-, PMMA, ABS+PMMA-, PP- or APET-plastic is used. In the method it is obviously also possible to use trowel pans made of, for example, essentially thin-walled plastic composite material.

As a further preferred alternative or complementary embodiments of the method, metal reinforced troweling elements 1b and/or concrete troweling elements 1b coupled to the actuator operating head A by a quick coupling principle, such as by form-fit, velcro-type and/or the like are used.

According to the said embodiments, referring in particular to FIG. 3, a one-piece circular metallic trowel pan 1a is removably coupled to the operating head A of the actuator used in troweling of the floor surface, whereby the fastening surfaces of the quick-locking arrangement between the trowel pan 1a and the plastic-structured trowel pan 1b are, on the one hand, male/female tape strips 2a fixed on the bottom surface P of the trowel pan 1a and, on the other hand, female/male tape strips 2b fixed on the rear surface T of the trowel pan 1b.

Respectively, with reference to the embodiment shown in FIGS. 4a and 4b, the quick-locking arrangement between the trowel blade 1b made of plastic-based material and the metallic trowel blade 1a (or an adapter) to be coupled to the rotor Al attachment arm is preferably implemented by a form-locking arrangement between the locking pin P1 at the bottom of the trowel pan 1a and the locking groove P2 on the top surface of the trowel pan 1b, whereby the locking pin P1 extends through the enlarged hole at the end of the locking groove P2 into the trowel blade 1b and when the trowel blade is moved longitudinally, locks in the vertical direction t. The trowel blade 1a is further provided with guides y and a retaining device z for engaging it by sliding on the rotor attachment arm,

It is obvious that the invention is not limited to the embodiments described or explained above, but can be modified in many different ways within the basic idea of the invention, for example by using the embodiments described in the accompanying drawings, partly in combination with each other, etc. Embodiments of the type shown in the accompanying drawings may also be implemented by means of structures and quick-locking arrangements which differ from those shown in the drawings in order to achieve the same basic purpose of the invention. Furthermore, the concrete troweling elements used in the method of the invention can be made of a wide variety of materials, using a wide variety of manufacturing techniques, in addition to the materials mentioned above, for example, bio-based, recyclable of biodegradable synthetic or organic materials, such as cellulose, etc.

1. A method for mechanical treatment of a concrete floor, such as troweling and blade finishing, using a hand-operated, a walk-behind or a ride-on actuator, such as a concrete power trowel, floor treating apparatus or the like, said actuator including one or more operating heads comprising a rotor consisting of two or more attachment arms, whereby troweling elements made of substantially plastic-based material, such as a circular trowel pan or elongated trowel blades attached to the rotor attachment arms, are detachably coupled to the actuator rotor, in particular to prevent discoloration of the treated floor surface during treatment, characterized in that in preparing a concrete floor with optimal physical and visual characteristics, a water-soluble silica-based medium is being applied on the said concrete floor before it is being troweled with the plastic-based concrete troweling elements, wherein said silica-based medium is preventing water evaporation from the concrete floor surface and sealing the treated surface, enabling the floor surface to have adequate moisture for cement hydration, wherein the silica-based medium is reacting with the excess lime in the cement, and thereby accelerating the formation of the surface.

2. The method according to claim 1, wherein a nanoparticulate silica-based medium is being used.

3. The method according to claim 1, wherein the concrete troweling elements made from ABS-, PS-, ABS+PC-, PETG-, PVC-, PMMA-, ABS+PMMA-, PP- or APET-plastic are being used.

4. The method according to claim 1, wherein the concrete troweling elements made from a plastic composite material are being used.

5. The method according to claim 1, wherein metal-reinforced concrete troweling elements (1b) are being used.

6. The method according to claim 1, wherein the concrete troweling elements capable of being connected to the actuator operating head by a quick-locking principle, such as form-locking, velcro-type attachment and/or the like are being used.
